(19) United States
(12) Patent Application Publication
(10) Pub. No.: US 2026/0029596 A1
(43) Pub. Date: Jan. 29, 2026

(54) REDUNDANCY-BASED HIGH RELIABILITY OPTOELECTRONIC ARCHITECTURE AND METHODS OF MAKING AND USING THE SAME

(71) Applicant: Taiwan Semiconductor Manufacturing Company Limited, Hsinchu (TW)

(72) Inventors: Tai-Chun Huang, New Taipei City (TW); Stefan Rusu, Sunnyvale, CA (US)

(21) Appl. No.: 18/784,790

(22) Filed: Jul. 25, 2024

(51) Int. Cl. G02B 6/42; H04Q 11/00

(52) U.S. Cl. CPC G02B 6/4286; G02B 6/4295; H04Q 11/0005; H04Q 2011/0015; H04Q 2011/0035; H04Q 2011/0039

(57) ABSTRACT

An optoelectronic device includes a first optical switch including a first optical input channel and a plurality of first optical output channels and configured to route an optical signal to a selected first optical output channel; a plurality of optical components having a respective optical input channel connected to a respective one of the plurality of first optical output channels; a first optical combiner configured to combine optical signals from the plurality of optical components and having a combiner optical output channel; a monitor circuit configured to receive an optical signal from the combiner optical output channel and configured to determine a functionality of the optical signal from the combiner optical output channel; and an optical routing controller configured to change designation of the selected first optical output channel among the plurality of first optical output channels based on a measurement signal from the monitor circuit.

### BACKGROUND

In the field of optical communication systems, ensuring the reliability and stability of components such as waveguides, modulators, and optoelectronic photodetectors is crucial. Related systems often face challenges related to process variations and component failures, which may affect the performance and yield of optical devices. At the system level, the inability to make modifications in the optoelectronic circuit after testing often results in circuit failures and substantial degradation of device performance, which severely limited the system's performance and adaptability.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1A is a vertical cross-sectional view of an optoelectronic device including a bonded assembly according to an embodiment of the present disclosure.

FIG. 1B is a vertical cross-sectional view of an optoelectronic device in which optical devices and semiconductor devices are provided in a hybrid die according to an embodiment of the present disclosure.

FIGS. 2A-2D are sequential vertical cross-sectional views of a region that corresponds to region M in FIG. 1A during a manufacturing process.

FIG. 3 is a top-down view of an exemplary configuration of a portion of an optical signal splitter or an optical switch.

FIG. 4 is a schematic diagram of a first exemplary optoelectronic circuit according to an embodiment of the present disclosure.

FIG. 5A is a schematic diagram of a first configuration of a second exemplary optoelectronic circuit according to an embodiment of the present disclosure.

FIG. 5B is a schematic diagram of a second configuration of the second exemplary optoelectronic circuit according to an embodiment of the present disclosure.

FIG. 5C is a schematic diagram of an optical splitter that may be used in various embodiments of the present disclosure.

FIG. 6A is a schematic diagram of a first configuration of a third exemplary optoelectronic circuit according to an embodiment of the present disclosure.

FIG. 6B is a schematic diagram of a second configuration of the third exemplary optoelectronic circuit according to an embodiment of the present disclosure.

FIG. 7 is a schematic diagram of a fourth exemplary optoelectronic circuit according to an embodiment of the present disclosure.

FIG. 8A is a schematic diagram of a first configuration of a fifth exemplary optoelectronic circuit according to an embodiment of the present disclosure.

FIG. 8B is a schematic diagram of a second configuration of the fifth exemplary optoelectronic circuit according to an embodiment of the present disclosure.

FIG. 9A is a schematic diagram of a first configuration of a sixth exemplary optoelectronic circuit according to an embodiment of the present disclosure.

FIG. 9B is a schematic diagram of a second configuration of the sixth exemplary optoelectronic circuit according to an embodiment of the present disclosure.

FIG. 10 is a schematic diagram of a seventh exemplary optoelectronic circuit according to an embodiment of the present disclosure.

FIG. 11 is a flow chart that illustrates steps for forming an optoelectronic device according to an embodiment of the present disclosure.

FIG. 12 is a flow chart that illustrates steps for operating an optoelectronic device according to an embodiment of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. Elements with the same reference numerals refer to the same element, and are presumed to have the same material composition and the same thickness range unless expressly indicated otherwise. As used herein, an element or a system “configured for” a function or an operation or “configured to” provide or perform a function or an operation refers to an element or a system that is provided with hardware, and with software as applicable, to provide such a function or such an operation as described in the present disclosure, and as known in the art in the event any details of such hardware or such software are not expressly described herein.

In the field of semiconductor manufacturing, particularly in the manufacture of optical components such as waveguides and metal layers, the primary focus has been on providing signal coupling between components such as the waveguide and the metal layer. However, practical challenges in the manufacturing sequence introduce process errors, leading to broken wires or suboptimal component characteristics, which compromise overall yield and reliability. Additionally, related component designs do not provide consideration for broader system-level integration, resulting in inefficiencies and a lack of cohesion in the final optoelectronic devices. At the system level, the inability to make modifications after testing often results in circuit failures and substantial waste of device area, which may limit system performance and adaptability.

Embodiments of the present disclosure provide enhancement in the stability and reliability of optoelectronic devices through a novel redundancy architecture. Redundant components are integrated into a photonic integrated die or into an electronic integrated die, thereby maximizing functional efficiency while minimizing device footprint and power consumption. Each multiplicate component is designed as a part of a redundancy system configured for real-time switching to backup components in the event of failure. Thus, the multiplicate components reduce device downtime and enhance device availability. Switching to backup components may be effected by an electrically-tunable output selector in an optical switch. The electrically-tunable output selector may include an Mach-Zehnder interferometer (MZI), a phase shifter, or a metal heater that may perform switching operations efficiently. Embodiments of the present disclosure may be used increase the production yield without compromising component stability in optoelectronic devices. The redundancy architecture of the present disclosure allow independent verification of functionality of individual optical or optoelectronic components during testing.

Embodiments of the present disclosure provide a novel redundancy architecture that ensures high stability of components during mass production of systems. The redundancy architecture of the present disclosure improves system reliability and stability by providing continuous operation of the optoelectronic device even when a primary component fails. In other words, the redundancy architecture of the present disclosure provide fault-tolerant, stable, and continuous device operation of the optoelectronic devices.

The redundancy architecture of the present disclosure enhances production output and allows for repair of an optoelectronic circuit during testing and real-time repair of on-site faults. Specifically, the redundant structure offers fault tolerance during manufacture, preventing critical failures caused by process errors, thereby improving the process yield and the production output. Additionally, when faults occur on-site, the redundant structure may quickly switch to backup components, rapidly repairing the fault and reducing production downtime, thus enhancing production efficiency. This architecture involves adding redundant structures that activate backup components with the same functionality when primary components fail, increasing system reliability and stability. Deactivation of a failed primary component and activation of a backup component may be performed during testing or on-site by using an optical routing controller, the operation of which is subsequently described in detail. Various aspects of the present disclosure are now described with reference to accompanying drawings.

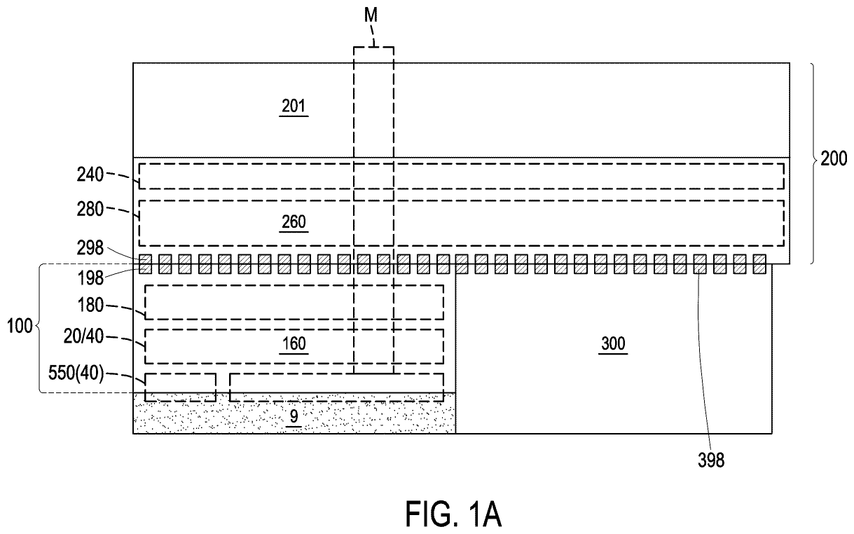

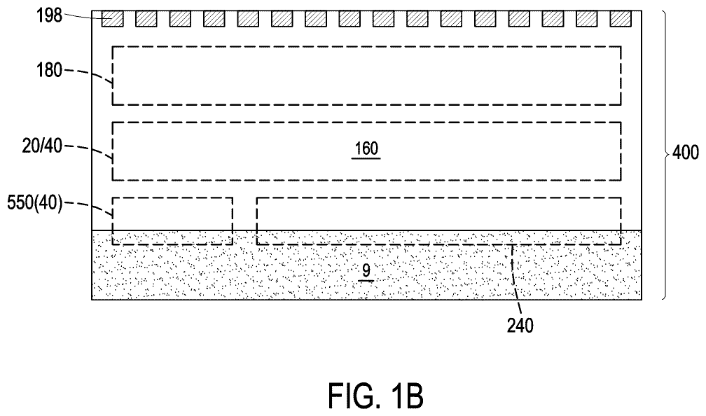

Referring to FIG. 1A, an exemplary bonded assembly including a photonic integrated die 100 and an electronic integrated die 200 is illustrated. As used herein, a “photonic integrated die” refers to a die that includes multiple photonic components and circuits. The photonic components typically encompass waveguides, optical switches, modulators, optical combiners, and optoelectronic photodetectors, which are utilized to manipulate, control, and detect optical signals. The photonic integrated die 100 provides high-density integration of photonic functionality, providing compact, efficient, and scalable solutions for optical communication and signal processing systems. The photonic integrated die 100 is designed to interface seamlessly with electronic components and circuits within the electronic integrated die 200 in order to facilitate hybrid integration with electronic integrated circuits for enhanced functionality and performance.

As used herein, an “electronic integrated die” refers to a die that includes a semiconductor substrate incorporating various electronic components and circuits therein. The electronic components typically include transistors, diodes, resistors, capacitors, and integrated circuits that are used to process electrical signals. The electronic integrated die 200 provides high-density integration of electronic functionality, providing compact, efficient, and scalable solutions for electronic processing and signal management. The electronic integrated die 200 is designed to interface seamlessly with photonic components and circuits in the photonic integrated die 100, allowing for the formation of an optoelectronic device that enhances overall system performance and functionality.

The photonic integrated die 100 comprises a photonic-die substrate 9, optical devices 40, and various waveguides 20 for directing propagation paths of photons. The photonic-die substrate 9 may comprise a semiconductor substrate such as a silicon substrate. The various waveguides 20 are configured to transmit optical signals therethrough, and as such, may be used as optical channels. A first subset of the optical channels functions as optical input channels for a respective optical device 40. A second subset of the optical channels functions as optical output channels for a respective optical device 40. An optical channel may be an optical output channel for a first optical device 40 and may be an optical input channel for a second optical device 40. In other words, some optical channels connect two optical devices 40 and function as an optical input channel and as an optical output channel, while some other optical channels function only as an optical input channel or only as an optical output channel. Thus, the first subset and the second subset are not mutually exclusive. The photonic integrated die 100 may further comprise photonic-die metal interconnect structures 180 embedded within photonic-die dielectric material layers 160. Photonic-die bonding pads 198 may be embedded within a most distal dielectric material layer within the photonic-die dielectric material layers 160.

The optical devices 40 may be any type of optical devices known in the art, and may include one or more of, silicon photonic devices, optical switches, optical amplifiers, optical filters, optical modulators, and optoelectronic photodetectors 550. The optoelectronic photodetectors 550, which is a subset of the optical devices 40, may be formed on the photonic-die substrate 9. Other optical devices 40 may be formed or placed within the photonic-die dielectric material layers 160. In some embodiments, a first subset of the photonic-die metal interconnect structures 180 may be formed as components of the optical devices 40, and a second subset of the photonic-die metal interconnect structures 180 may be used to provide metal wiring for the optical devices 40. Optical paths may be provided between a subset of the waveguides 20 and optical input nodes of the optoelectronic photodetectors 550. A subset of the photonic-die metal interconnect structures 180 may comprise metal via structures contacting the electrical output nodes of the optoelectronic photodetectors 550. The photonic-die bonding pads 198 may be configured for metal-to-metal bonding, controlled collapse chip connection (C4) bonding, or microbump bonding (also referred to as C2 bonding).

The electronic integrated die 200 comprises a semiconductor die including a semiconductor substrate 201 and semiconductor devices 240 located on the semiconductor substrate 201. The semiconductor devices 240 comprises optoelectronic devices such as optoelectronic photodetectors and complementary metal-oxide-semiconductor (CMOS) devices such as field effect transistors. The CMOS devices may comprise a control circuit for controlling operation of the optical devices 40. The electronic integrated die 200 may further comprise electronic-die metal interconnect structures 280 embedded within electronic-die dielectric material layers 260. Electronic-die bonding pads 298 may be formed within a most distal dielectric material layer within the electronic-die dielectric material layers 260. The electronic-die bonding pads 298 may be configured for metal-to-metal bonding, controlled collapse chip connection (C4) bonding, or microbump bonding (also referred to as C2 bonding).

Generally speaking, optical paths are provided between the waveguides 20 and the optoelectronic photodetectors 550 in the photonic integrated die 100. Electrical signal paths for transmitting data signals, i.e., which are electrically conductive paths, are provided between the output electrical nodes of the optoelectronic photodetectors 550 in the photonic integrated die 100 and input nodes of the control circuit within the electronic integrated die 200. Electrical signal paths for transmitting control signals, i.e., which are electrically conductive paths, are provided between the control circuit within the electronic integrated die 200 and a subset of the optical devices 40 within the photonic integrated die 100. The control signals may be transmitted across the photonic integrated die 100 and the electronic integrated die 200 through electrically conductive paths including a respective bonded pair of a photonic-die bonding pad 198 and a electronic-die bonding pad 298. While various embodiments may be described such that the electronic-die bonding pads 298 are bonded to the photonic-die bonding pads 198 via metal-to-metal bonding to provide electrically conductive paths extending across the photonic integrated die 100 and the electronic integrated die 200, other embodiments are expressly contemplated herein in which the electrically conductive paths comprise bonding structures including solder balls.

Optionally, at least one additional die 300 may be attached to the electronic integrated die 200. The at least one additional die 300, if present, may comprises a semiconductor die including at least one field effect transistor therein. The at least one additional die 300 may comprise a logic die, a memory die, a passive device die, or any other type of semiconductor die. The at least one additional die 300 may comprise additional bonding pads 398, which are bonded to a subset of the electronic-die bonding pads 298 in the electronic integrated die 200.

FIG. 1B is a vertical cross-sectional view of an optoelectronic device in which optical devices 40 and semiconductor devices 240 are provided in a hybrid die 400 according to an embodiment of the present disclosure. The hybrid die 400 may be derived from the photonic integrated die 100 illustrated in FIG. 1A by forming semiconductor devices 240 on the photonic-die substrate 9. The photonic-die metal interconnect structures 180 provide electrical connections between the optical devices 40 and semiconductor devices 240. In embodiments in which a hybrid die 400 is used, the hybrid die 400 may provide the functionality of the combination of the photonic integrated die 100 and the electronic integrated die 200 described with reference to FIG. 1A.

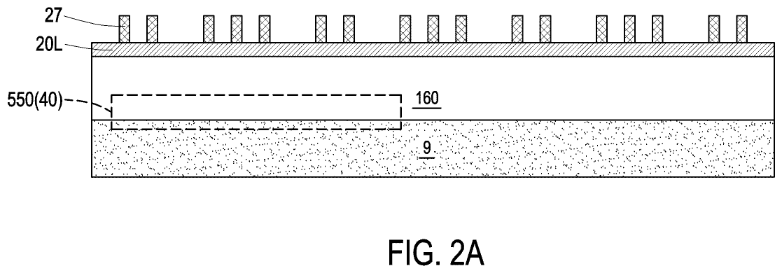

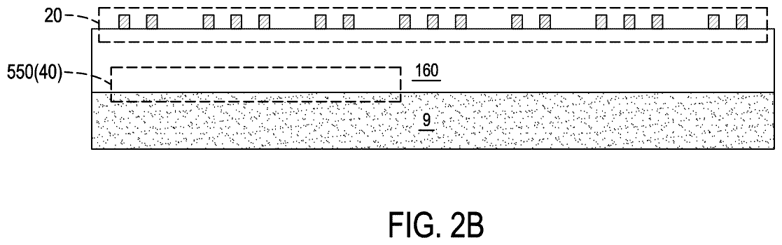

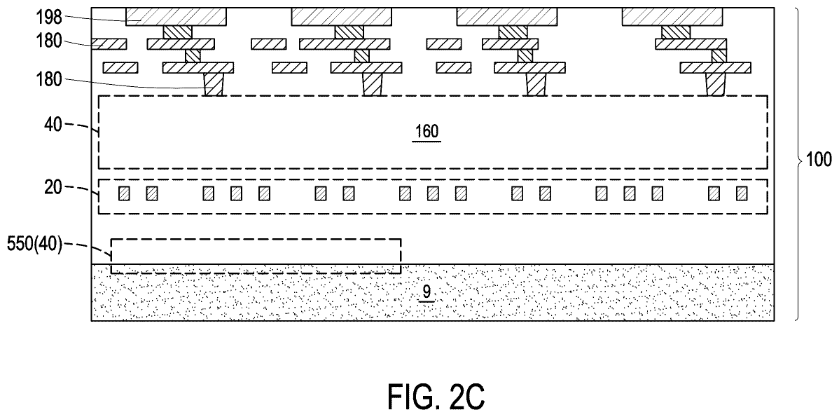

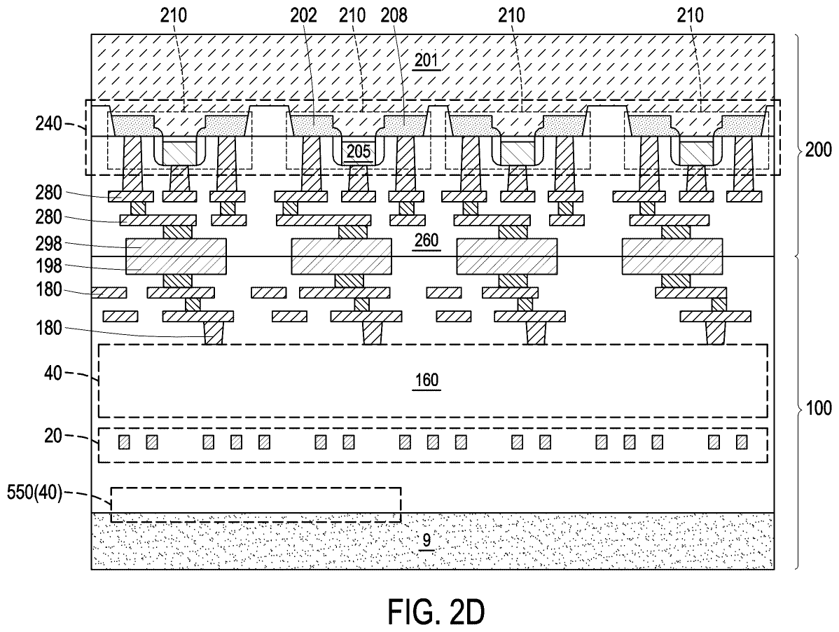

FIGS. 2A-2D are sequential vertical cross-sectional views of a region that corresponds to region M in FIG. 1A during a manufacturing process.

Referring to FIG. 2A, optoelectronic photodetectors 550 may be formed on the photonic-die substrate 9. The optoelectronic photodetectors 550 are a subset of the optical devices 40 that are formed on, or over, the photonic-die substrate 9. A photonic-die dielectric material layer 160 may be formed over the photonic-die substrate 9 and the optoelectronic photodetectors 550. The photonic-die dielectric material layer 160 comprises a dielectric material such as silicon oxide. The thickness of the photonic-die dielectric material layer 160 may be in a range from 0.5 micron to 10 microns, such as from 1 micron to 5 microns, although lesser and greater thicknesses may also be used.

A waveguide material layer 20L may be deposited over the photonic-die dielectric material layer 160 as a blanket material layer having a uniform thickness throughout. The waveguide material layer 20L comprises a material having a higher refractive index than the material of the photonic-die dielectric material layer 160. For example, in embodiments in which the photonic-die dielectric material layer 160 comprises silicon oxide, the waveguide material layer 20L may comprise silicon or silicon nitride. The thickness of the waveguide material layer 20L may be in a range from 100 nm to 500 nm, although lesser and greater thicknesses may also be used.

A photoresist layer 27 may be applied over the waveguide material layer 20L, and may be lithographically patterned into a patten of optical signal splitters to be subsequently formed. The pattern of the optical signal splitters are subsequently described in detail.

Referring to FIG. 2B, the pattern in the photoresist layer 27 may be transferred through to the waveguide material layer 20L by performing an anisotropic etch process. The photoresist layer 27 may be used as an etch mask layer, and the waveguide material layer 20L may be patterned into various waveguides 20, which comprise various optical channels and components of various optical devices 40 (which may include optical switches, various optical components, and optical combiners). The photoresist layer 27 may be subsequently removed, for example, by ashing. The width of various segments of each waveguide 20 may be uniform throughout, and may be in a range from 100 nm to 500 nm, although lesser and greater widths may also be used.

Referring to FIG. 2C, additional photonic-die dielectric material layers 160 and optical devices 40 may be subsequently formed. The optical devices 40 may comprise any optical devices known in the art. Photonic-die metal interconnect structures 180, photonic-die bonding pads 198, and photonic-die bonding pads 198 may be formed within the additional photonic-die dielectric material layers 160. The photonic-die metal interconnect structures 180 and the photonic-die bonding pads 198 may be formed within the additional photonic-die dielectric material layers 160, and may be electrically connected to electrical nodes of the optical devices 40.

Referring to FIG. 2D, an electronic integrated die 200 may be provided. The electronic integrated die 200 may be any type of semiconductor die, such as a system-on-integrated-chip (SoIC) die, a central processor unit, a graphic processor unit, a memory die, etc. The electronic integrated die 200 may comprise semiconductor devices 240 formed on a top surface of a semiconductor substrate 201. The semiconductor devices 240 may include field effect transistors 210. Electronic-die dielectric material layers 260 are formed over the semiconductor devices 240. The combination of the semiconductor devices 240 and a subset of the electronic-die metal interconnect structures 280 comprises a control circuit configured to generate control signals for the optical devices 40 within the photonic integrated die 100. Each field effect transistor 210 may comprise a respective gate electrode 205, a respective gate dielectric, a respective source region 202, and a respective drain region 208. Generally, the electronic integrated die 200 comprises a semiconductor substrate 201, a control circuit including semiconductor devices (such as field effect transistors 210), electronic-die metal interconnect structures 280, and electronic-die bonding pads 298 that are formed within electronic-die dielectric material layers 260.

The electronic integrated die 200 may be attached to the photonic integrated die 100 by bonding the electronic-die bonding pads 298 to the photonic-die bonding pads 198 directly by metal-to-metal bonding, or indirectly via an array of solder material portions (such as solder balls).

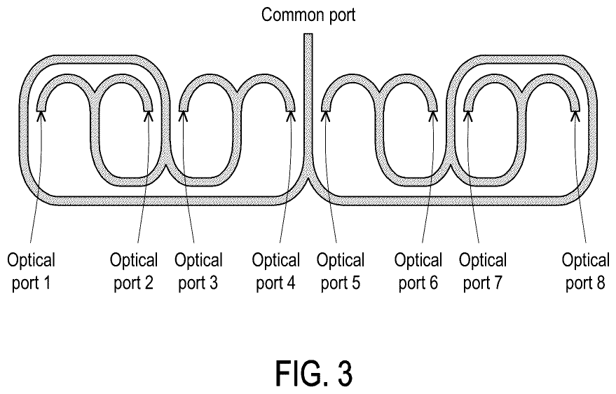

FIG. 3 is a top-down view of an exemplary configuration of a portion of an optical signal splitter or an optical switch. Generally, a common port and a plurality of optical ports (such as optical port 1, optical port 2, . . . , and optical port 8). In embodiments in which the common port is used as an optical input channel, and in embodiments in which the plurality of optical ports is used as multiple optical output channels, such an optical device may be used as an optical switch. In embodiments in which the plurality of optical ports are used as optical input ports and in embodiments in which the common port is used as an optical output port, such an optical device may be used as an optical combiner. In embodiments in which an optical device 40 is an optical switch, an electrically-tunable output selector (not expressly shown) may be incorporated into such an optical device 40. The electrically-tunable output selector may be selected from an Mach-Zehnder interferometer, an electrically-tunable phase shifter, and a metal heater. Generally, the total number of optical ports within the plurality of optical ports may be in a range from 2 to 128, although a greater number may also be used. While the present disclosure is described using an embodiment in which the total number of optical ports within a plurality of optical ports is 8, embodiments are expressly contemplated in which the total number of optical ports (except the common port) is a number greater than 1 is not 8. Further, it is understood that the configuration illustrated in FIG. 3 is only exemplary, and any shapes suitable as a waveguide may be used as components of optical devices 40.

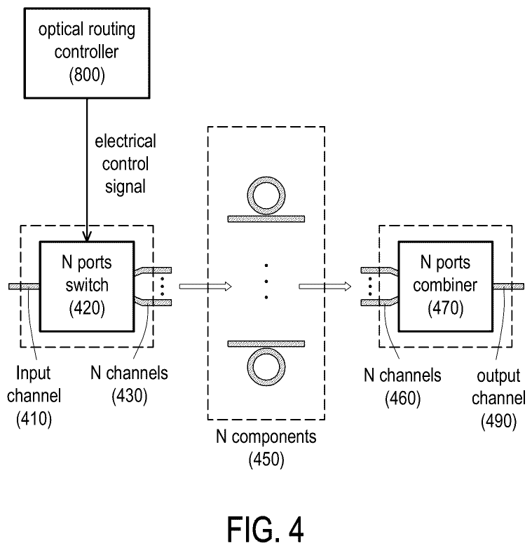

Referring to FIG. 4, a schematic diagram of a first exemplary optoelectronic circuit representing an optoelectronic device of the present disclosure is illustrated. According to various embodiments disclosed herein, the first exemplary optoelectronic circuit comprises a combination of a first optical switch 420 and a first optical combiner 470, which addresses the yield issues of native components during manufacture, and improves the reliability and stability of the optoelectronic device. The optoelectronic device may be dynamically configured to provide system flexibility and scalability. The optoelectronic device comprises a redundancy architecture which improve fault tolerance and reliability.

The first exemplary optoelectronic circuit comprises a first optical switch 420, which may be an N ports switch, i.e., an optical switch having N optical output ports. N is a positive integer greater than 1, i.e., an integer such as 2, 3, 4, 5, 6, 7, 8, etc. The first optical switch 420 comprises a first optical input channel 410, and N first optical output channels 430.

The first optical switch 420 controls the switching of channels. An optical switch is a device that selectively routes optical signals from one channel to another. An optical switch changes configurations of an optical network, and allows dynamic reconfiguration of signal paths without converting optical signals to electrical signals and vice versa. In one embodiment, the first optical switch 420 comprises an electrically-tunable output selector that comprises a Mach-Zehnder interferometer including an electrically-tunable phase shifter.

Generally speaking, a Mach-Zehnder interferometer (MZI), a phase shifter, and a metal heater are interrelated, and may be used to provide a functional optical switch. A Mach-Zehnder interferometer is a photonic device for modulating and switching optical signals. A Mach-Zehnder interferometer two arms that split and then recombine the light, creating interference patterns. By adjusting the relative phase of the light in the two arms, one may control the output intensity, effectively modulating the signal. A phase shifter is a component that alters the phase of an optical signal. In the context of an MZI, phase shifters are used to control the phase difference between the two arms of the interferometer. This phase control is crucial for achieving the desired interference pattern and thus for modulating or switching the optical signal. A metal heater may be used as a mechanism to induce phase shifts in optical waveguides. By applying current through the metal heater, it generates heat, which changes the refractive index of the waveguide material (usually through the thermo-optic effect). This change in refractive index alters the phase of the optical signal passing through the waveguide.

The first exemplary optoelectronic circuit further comprises N optical components 450, which are also referred to as N main components. The N optical components 450 may be optical components having an identical design, or may be optical components configured to provide the same function or a similar function. Generally, the N optical components 450 may be multiple instances of any optical component known in the art, or may be optical components having a similar design with differing design parameters (such as dimensions). Each of the N optical components 450 may be configured to provide a key function of the optoelectronic circuit of the present disclosure. Each optical input node of the N optical components 450 may be optically coupled to a respective one of the N first optical output channels 430. Each output node of the N optical components 450 comprises an optical component output channel 460. N optical component output channels 460 may be provided.

Exemplary optical devices that may be used as the N optical components 450 of the present disclosure include, but are not limited to, optical switches, Mach-Zehnder interferometers (MZIs), phase shifters, optical combiners, optical splitters, modulators, attenuators, filters, and wavelength-division multiplexers. In embodiments in which optical switches are used as the N optical components 450, it is understood that an optical switch within one of the N optical components 450 provides a primary switching function, and multiple instances of the first optical switch 420 may be used to provide multiple source signals for each of the N optical components 450 (i.e., the main optical switches) as the multiple optical inputs for the N optical components 450. Generally, the N optical components 450 perform the primary optical signal processing function, and the first optical switch 420 provides the function of directing an input signal to on of the N first optical output channels 430. Likewise, for any function that an optical component 450 of the present disclosure provides, the first optical switch 420 provides the function of directing an input signal to on of the N first optical output channels 430.

Each of the N optical components 450 is configured to perform the essential functions of the optoelectronic circuit. For instance, optical switches may selectively route optical signals between different paths, while MZIs may be used for signal modulation or switching by exploiting interference effects. Phase shifters may adjust the phase of optical signals to achieve desired interference patterns or to synchronize signals within the circuit. Optical combiners merge multiple optical signals into a single output channel, optimizing the use of the optical infrastructure. Optical splitters, on the other hand, divide a single optical signal into multiple paths, enabling parallel processing or distribution of the signal. Modulators may vary the intensity, phase, or polarization of optical signals to encode information, while attenuators control the power level of the signals. Filters may selectively transmit or block specific wavelengths, aiding in signal processing and management. Wavelength-division multiplexers combine or separate signals of different wavelengths, increasing the data-carrying capacity of the optical network. Each of these optical devices may be tailored to specific design parameters to meet the requirements of the optoelectronic circuit, ensuring optimal performance and functionality.

During operation, the first optical switch 420 may utilize a Mach-Zehnder interferometer (MZI) with phase shifters and/or metal heaters to manage the switching and direct the optical energy to a selected optical component 450. By default, without any bias, a primary optical component 450 (e.g., a default optical component 450) among the N optical components 450 is selected. The N optical components 450 provide the redundancy features of the present disclosure.

Using identical component parameters (e.g., dimensions of patterns) for the N optical components 450 improves yield during manufacture. Using different component parameters for the N optical components 450 facilitates testing and identification of optimal device parameters. Same component parameters among the N optical components may be utilized if the functionality of an optical component 450 is dependent primarily on the process yield and local defects. Different component parameters among the N optical components 450 may be utilized if the functionality of an optical component 450 is dependent primarily on the device design.

In a non-limiting example, the optical components 450 may comprise transmitters, such as modulators. High stability and reliability are important for transmitters. To enhance the yield and mitigate the risk of component failure, redundancy techniques using N instances of the transmitter may be used. For instance, compared to optical components that do not utilize redundancy techniques, the optical components 450 incorporating redundancy exhibit higher yield and more efficient area usage, minimizing processing issues and enhancing overall usability. By implementing redundancy architecture incorporating N optical components 450, system performance and reliability may be enhanced for the optoelectronic circuit. The redundancy architecture of the present disclosure not only safeguards against component failures, but also provides enhanced production yield and system stability, thereby boosting the overall robustness of the optoelectronic device.

The first exemplary optoelectronic circuit further comprises a first optical combiner 470. An optical combiner is a device that merges multiple optical signals into a single output channel. Thus, the first optical combiner 470 combines the optical output from the N optical component output channel 460, and provides a combined optical output through a combiner optical output channel 490. In other words, the first optical combiner 470 integrates the optical signals from the N optical component output channel 460, and facilitates efficient transmission of the combined optical signal over a single optical fiber or waveguide, which functions as the combiner optical output channel 490.

The first optical combiner 470 is designed to combine signals with minimal insertion loss, thereby maintaining the power of the combined signal for further transmission and processing. In the context of wavelength-division multiplexing (WDM) systems, the first optical combiner 470 merges signals of different wavelengths into a single fiber, optimizing bandwidth utilization and increasing network capacity. Additionally, the first optical combiner 470 effectively handles interference between combined signals by using techniques such as directional couplers, multi-mode interference (MMI) couplers, or other structures to ensure constructive signal integration.

Various types of optical combiners may be used depending on the specific application requirements. These include directional couplers, which use evanescent coupling to combine signals from two waveguides into one; MMI couplers, which utilize the self-imaging principle of multimode waveguides to merge multiple signals; star couplers, particularly useful in passive optical networks (PONs) for combining signals from multiple input fibers into one output fiber; and WDM multiplexers, which combine signals of different wavelengths using wavelength-selective components such as diffraction gratings or thin-film filters. Each of these combiners may be tailored to specific design parameters to meet the requirements of the optoelectronic circuit, ensuring optimal performance and functionality.

The incorporation of the first optical combiner 470 into the optoelectronic circuit allows for the dynamic combination of optical signals from the N optical components 450, enhancing the flexibility and scalability of the system. By merging multiple optical signals into a single output, the first optical combiner 470 optimizes the use of optical infrastructure and increases the data-carrying capacity of the network. This integration is particularly beneficial in applications such as optical communication networks, laser systems, and photonic integrated circuits (PICs), where the efficient management and routing of optical signals are critical for optimal system performance.

Thus, the first optical combiner 470 primarily adjusts optical energy through the optical components 450 and integrates the optical energy. Phase issues, based on system applications or component characteristics, are also considered, with optional phase shifters that may be added to adjust the phase and ensure maximum energy output.

Generally, the first optical switch 420 comprises a first optical input channel 410 and a plurality of first optical output channels 430. The first optical switch 420 is configured to route an optical signal received through the first optical input channel 410 to a selected first optical output channel 430 which is one of the N first optical output channels 430. According to an aspect of the present disclosure, determination of the selected first optical output channel 430 among the N first optical output channels 430 may be performed using an optical routing controller 800, which is a subset of the semiconductor devices 240 described above. The optical routing controller 800 is configured to change designation of the selected first optical output channel 430 among a plurality of first optical output channels 430 (i.e., the N first optical output channels 430) based on a measurement signal from a monitor circuit, which is subsequently described using specific embodiments.

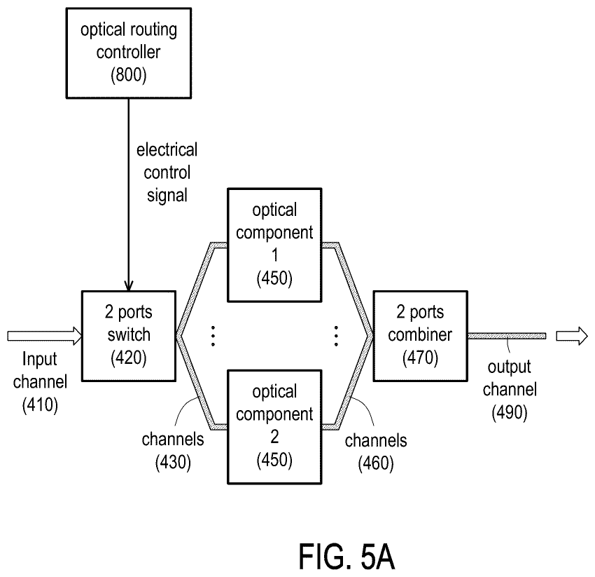

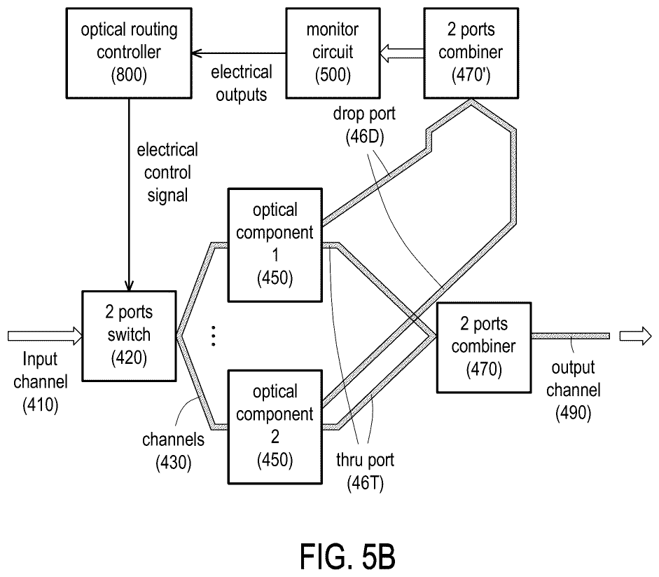

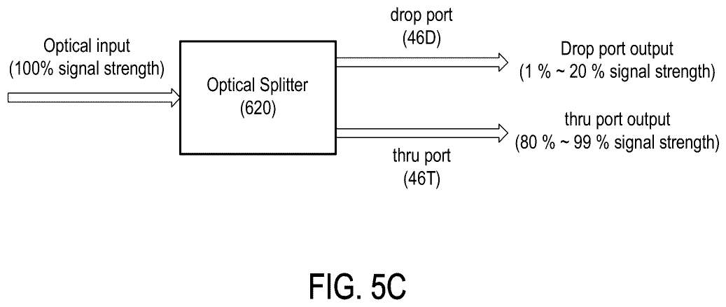

Referring to FIG. 5A, a first configuration of a second exemplary optoelectronic circuit is illustrated according to an embodiment of the present disclosure. The first configuration of the second exemplary optoelectronic circuit may be derived from the first exemplary optoelectronic circuit illustrated in FIG. 4 by setting the value of the integer N at 2.

Referring to FIGS. 5B and 5C, a second configuration of the second exemplary optoelectronic circuit may be derived from the first configuration of the second exemplary electronic circuit illustrated in FIG. 5A by incorporating a monitor circuit 500 that monitors the optical outputs from the optical components 450. An optical splitter 620, i.e., a power splitter, may be incorporated into each of the optical components 450. Specifically, a terminal end (i.e., an output end) of each optical component 450 may comprise an optical splitter 620 that provides a thru port 46T and a drop port 46D as two optical output ports. A predominant fraction of the optical output from the device portion of the optical component 450 is directed to the thru port 46T, and a minor fraction of the optical output from the device portion of the optical component 450 is directed to the drop port 46D. In an illustrative example, about 80% to 99% of the optical energy (i.e., the signal strength) from the device portion of the optical component 450 may be directed to the thru port 46T, and about 1% to 20% of the optical energy from the device portion of the optical component 450 may be directed to the drop port 46D.

The optical outputs from the drop ports 46D of the optical components 450 may be directed to an additional optical combiner 470′, and may be subsequently directed to the monitor circuit 500. In embodiments in which absence of an optical signal from the optical output of the additional optical combiner 470′ is detected by the monitor circuit 500, this information is transmitted to the optical routing controller 800 in the form of an electrical signal. The optical routing controller 800 subsequently determines that the currently selected optical component 450 (which includes the only activated optical path between the first optical switch 420 and the additional optical combiner 470′ at the time of detection) failed to properly transmit and/or process the optical input signal provided by the first optical switch 420. At this point, the optical routing controller 800 may deactivate the previously selected first optical output channel 430, and activate a newly selected first optical output channel 430, which transmits the optical signal through the first optical switch 420 to another optical component 450.

The combination of the monitor circuit 500 and the optical routing controller 800 constitutes a feedback system. The monitor circuit 500 may comprise at least one optoelectronic photodetector 550 described with reference to FIGS. 1A-2D. An embedded optical splitter 620, which incorporated into the output node of each of the optical components 450, may be utilized as a switching element without the need for 100% switching efficiency, allowing a fraction of the optical output energy to be transferred to the feedback system. The incorporation of redundancy architecture with a feedback system facilitates automatic switching. The feedback system uses at least one optoelectronic photodetector 550 and drop ports 46D of optical splitters 620.

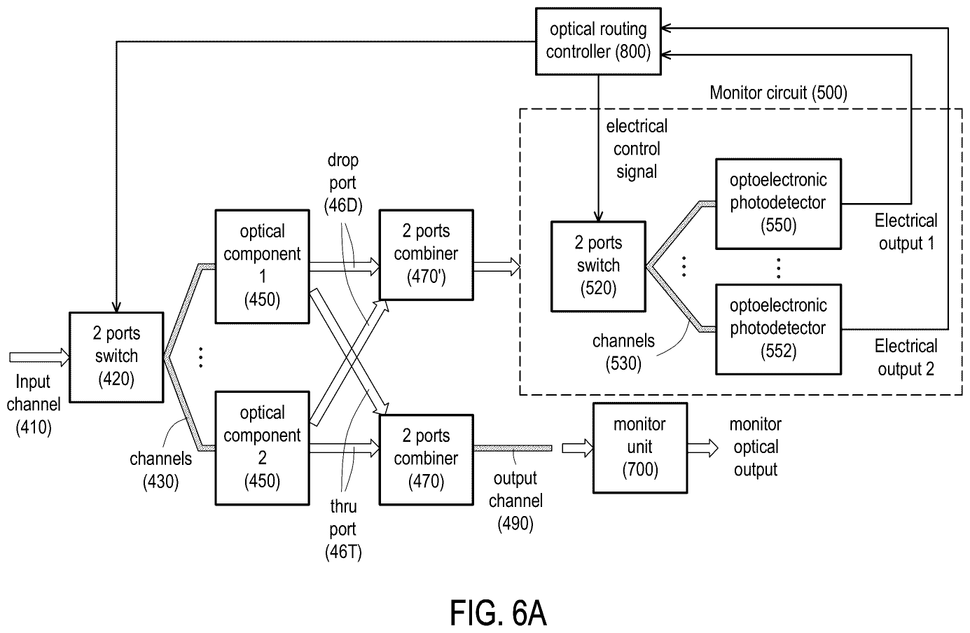

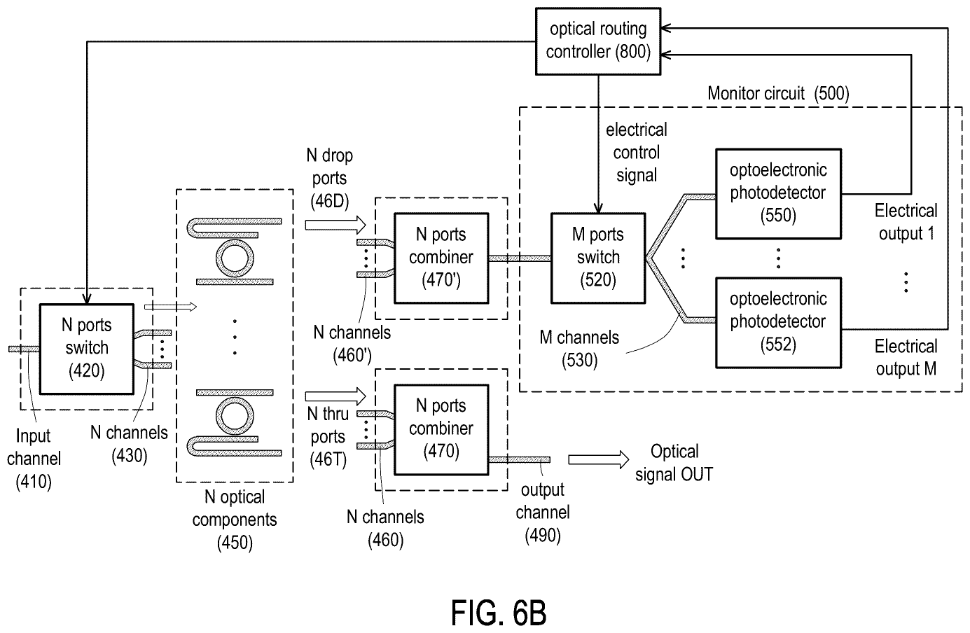

Referring to FIGS. 6A and 6B, a first configuration and a second configuration of a third exemplary optoelectronic circuit are illustrated, respectively. The first configuration of the third exemplary optoelectronic circuit of FIG. 6A and be derived from the second configuration of the second exemplary optoelectronic circuit of FIG. 5B by using a specific embodiment for the monitor circuit 500, and by optionally attaching an optical monitor unit 700 to the combiner optical output channel 490. The optical output from the optical monitor unit 700 is herein referred to as a monitor optical output. Generally, the optical monitor unit 700 may comprise any optical monitor device known in the art and/or any optical encryption device known in the art. For example, the optical monitor unit 700, if present, may comprise a wavelength meter, an optical spectrum analyzer, a power meter, or alternative optical devices configured to analyze the optical signals for wavelength accuracy, phase shift, power levels, and/or spectral characteristics. Additionally, the optical monitor unit 700 may include encryption devices to ensure secure transmission of optical signals.

The first configuration of the third exemplary structure illustrated in FIG. 6A uses two optical components 450, and the second configuration of the third exemplary structure illustrated in FIG. 6B uses N optical components 450 in which N may be any integer greater than 1. Each monitor circuit 500 includes a plurality of series connections of a respective monitor-circuit optical channel 530 and a respective optoelectronic photodetector 550 configured to generate a respective electrical signal (i.e., electrical output) upon detection of an optical signal thereupon. Each monitor-circuit optical channel 530 may be an optical output channel of the second optical switch 520, and thus, is also referred to as second optical output channel 530. The first configuration of the third exemplary structure illustrated in FIG. 6A uses two series connections of a respective monitor-circuit optical channel 530 and a respective optoelectronic photodetector 550, and the second configuration of the third exemplary structure illustrated in FIG. 6B uses M series connections of a respective monitor-circuit optical channel 530 and a respective optoelectronic photodetector 550. M may be any integer greater than 1. The series connections of a respective monitor-circuit optical channel 530 and a respective optoelectronic photodetector 550 provide 2-fold redundancy or M-fold redundancy against failure of the monitor-circuit optical channel 530 and against failure of the optoelectronic photodetector 550 for any reason (e.g., due to process yield issues, due to reliability issues or device degradation, or due to usage).

In one embodiment, each monitor circuit 500 comprises a second optical switch 520, and the second optical switch 520 is configured to route the optical signal from the combiner optical output channel 490 to a selected second optical output channel which is one of the monitor-circuit optical channels 530. In one embodiment, the optical routing controller 800 is configured to change designation of the selected second optical output channel among the monitor-circuit optical channels 530 based on the measurement signal from the monitor circuit 500.

Generally, the monitor circuit 500 may be configured to receive an optical signal from the combiner optical output channel 490, and may be configured to determine a functionality of the optical signal from the combiner optical output channel 490. The metric for the functionality of the optical signal from the combiner optical output channel 490 may be generation of an electrical output (such as photovoltaic current) at a sufficiently high magnitude, i.e., an electrical output above a threshold value. The monitor circuit 500 comprises at least one optoelectronic photodetector 550 configured to generate at least one electrical signal from the optical signal from the combiner optical output channel 490 as the measurement signal of the monitor circuit 500.

The optical routing controller 800 may be configured to change the designation of the selected first optical output channel 430 based on a magnitude of the electrical signal that is generated by the monitor circuit 500, and/or to change the designation of the selected second optical output channel among the monitor-circuit optical channels 530 based on the measurement signal from the monitor circuit 500. Generally, failure to generate the electrical output from a selected optoelectronic photodetector 550 to which the output of the second optical switch 520 is directed may be due to failure of the selected optoelectronic photodetector 550 or due to failure of the selected optical component 450 to which the output of the first optical switch 420 is directed. In one embodiment, the optical routing controller 800 may change the designation of the selected first optical output channel 430 first to test whether activation of an alternative first optical output channel 430 (and an alternative optical component 450) resolves the detected absence of sufficient electrical output from the selected optoelectronic photodetector 550, and subsequently change the designation of the selected second optical output channel 530 only if activation of the alternative optical component(s) 450 does not restore the electrical output from the selected optoelectronic photodetector 550. In an alternative embodiment, the optical routing controller 800 may change the designation of the selected second optical output channel 530 first to test whether activation of an alternative second optical output channel 530 (and an alternative optoelectronic photodetector 550) causes generation of sufficient electrical output from the newly selected optoelectronic photodetector 550, and subsequently change the designation of the selected first optical output channel 430 only if activation of the alternative optoelectronic photodetector 550 fails to cause generation of a sufficient electrical output from the newly selected optoelectronic photodetector 550.

In one embodiment, the first optical switch 420, the plurality of optical components 450, the first optical combiner 470, the additional optical combiner 470′, the first optical combiner 470, the second optical switch 520, and the at least one optoelectronic photodetector 550 may be located in a photonic integrated die 100, and the optical routing controller 800 may be located in an electronic integrated die 200. In one embodiment, the photonic integrated die 100 and the electronic integrated die 200 are bonded to each other directly or through at least one intermediate die such that at least one optical path is provided between the first optical combiner 470 and the at least one photonic integrated die 100. In one embodiment, at least one electrically conductive path extends from an output node of the optical routing controller 800 to a control node of the first optical switch 420, and each of the at least one electrically conductive path comprises a respective photonic-die bonding pad 198 and a respective electronic-die bonding pad 298.

Alternatively, the first optical switch 420, the plurality of optical components 450, the first optical combiner 470, the additional optical combiner 470′, the first optical combiner 470, the second optical switch 520, the at least one optoelectronic photodetector 550, and the optical routing controller 800 may be located in a hybrid die 400.

In one embodiment, the first optical switch 420 comprises an electrically-tunable output selector that comprises a Mach-Zehnder interferometer including an electrically-tunable phase shifter, and the optical routing controller 800 is configured to generate an electrical control signal that is applied to the electrically-tunable output selector. In one embodiment, the second optical switch 520 comprises an additional electrically-tunable output selector that comprises a Mach-Zehnder interferometer including an electrically-tunable phase shifter, and the optical routing controller 800 is configured to generate an electrical control signal that is applied to the additional electrically-tunable output selector.

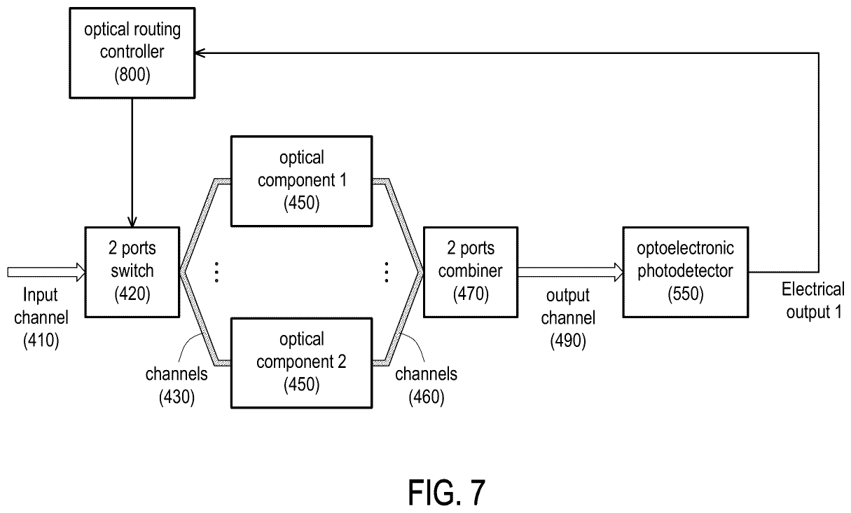

Referring to FIG. 7 a fourth exemplary optoelectronic circuit according to an embodiment of the present disclosure is illustrated, which may be derived from the first and second exemplary optoelectronic circuits of FIGS. 4 and 5A by connecting an optoelectronic photodetector 550 to the combiner optical output channel 490. In this embodiment, the optoelectronic photodetector 550 may function as a monitor circuit 500 described with reference to FIGS. 6A and 6B. The electrical output from the optoelectronic photodetector 550 may be a measurement signal, which is an electrical input signal for the optical routing controller 800 which generates electrical output signals for the first optical switch 420.

In one embodiment, the conversion of the optical energy in the optical beam through the combiner optical output channel 490 to electrical energy in the electrical output of the optoelectronic photodetector 550 may be facilitated by tuning the wavelengths of the photons propagating through the combiner optical output channel 490. In one embodiment, a metal heater may be provided on the waveguide 20 which is used as the combiner optical output channel 490 to adjust the wavelengths of the photons therein. To ensure the reliability of the optoelectronic photodetector 550 during mass production, redundancy architecture may be used for the optoelectronic photodetector 550 in the fourth exemplary optoelectronic circuit, which may stabilize the conversion of optical energy into electrical energy, thereby enhancing the stability of the receiver system.

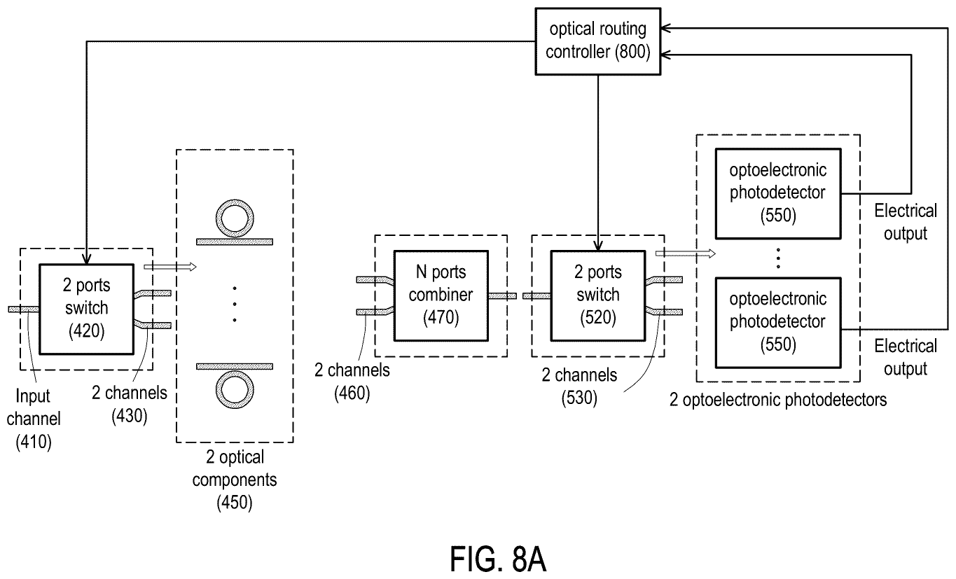

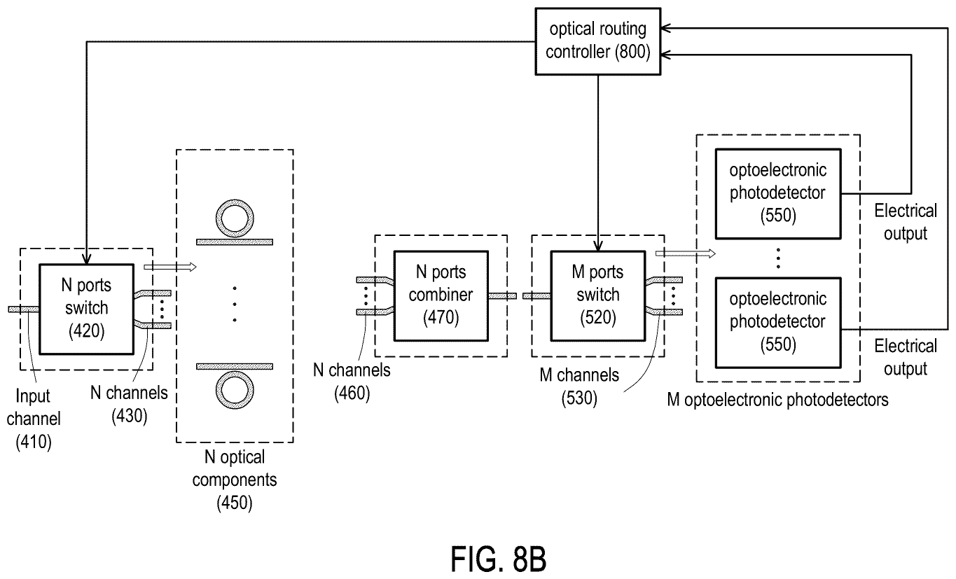

Referring to FIGS. 8A and 8B, a first configuration and a second configuration, respectively, of a fifth exemplary optoelectronic circuit according to an embodiment of the present disclosure are illustrated. The fifth exemplary optoelectronic circuit implements the redundancy architecture of the present disclosure for the optoelectronic photodetector 550 in the fourth exemplary optoelectronic circuit. The first configuration of FIG. 8A corresponds to the embodiment in which two optical components 450 and two optoelectronic photodetectors 550 are used. The second configuration of FIG. 8B corresponds to the embodiment in which N optical components and M optoelectronic photodetectors 550 are used, in which N is a first integer greater than 1, and M is a second integer greater than 1. The optoelectronic photodetector 550 in the fourth exemplary optoelectronic circuit may be replaced with a monitor circuit 500 described with reference to FIG. 6A to provide the first configuration of the fifth exemplary structure. The second configuration of the fifth exemplary structure may be derived from the first configuration of the fifth exemplary structure by using an N-fold redundancy for the optical component 450, and by using an M-fold redundancy for the series connections of a respective monitor-circuit optical channel 530 and a respective optoelectronic photodetector 550.

Generally, use of the monitor circuits 500 illustrated in FIGS. 8A and 8B enhances the stability and efficiency of the optoelectronic device of the present disclosure by using redundancy architecture within the monitor circuits 500. In other words, a twofold redundancy or an M-fold redundancy in the optoelectronic photodetector 550 ensures that the optoelectronic device may be repaired at a test step during manufacture, and/or during operation in the field. The redundancy architecture ensures stable operation of the optical components 450, and stable and efficient optoelectronic conversion by the optoelectronic photodetectors 550. Thus, the reliability and fault tolerance of the optoelectronic device are improved, the failure rate is reduced, and stable and efficient operation of the system containing the optoelectronic device is ensured.

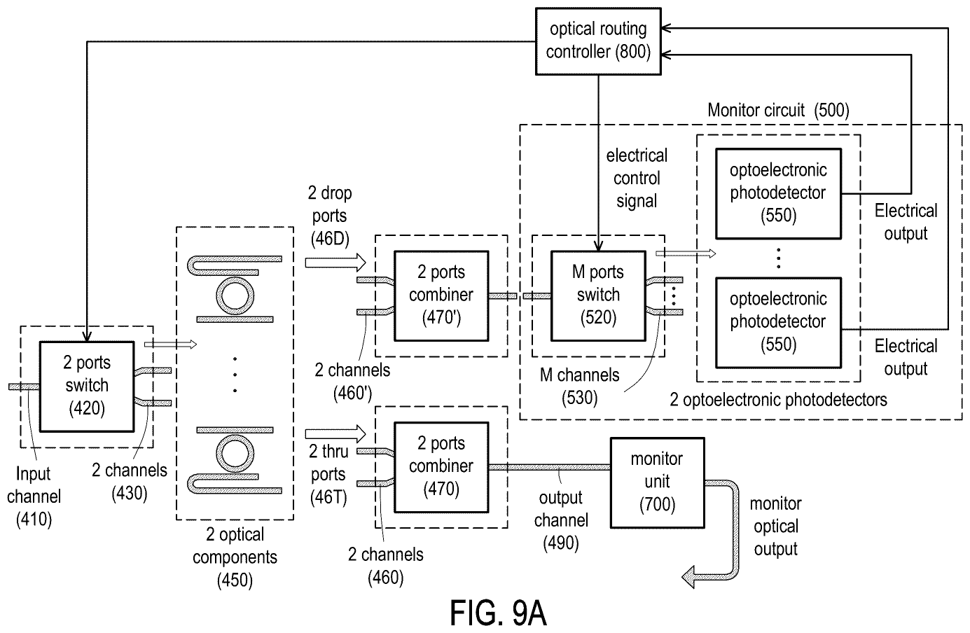

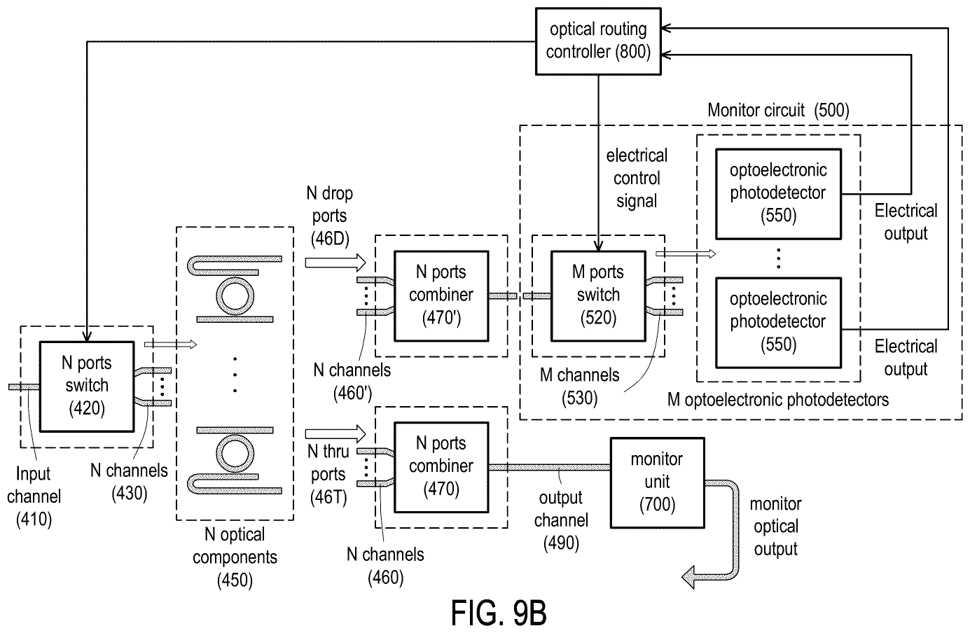

Referring to FIGS. 9A and 9B, a first configuration and a second configuration, respectively, of a sixth exemplary optoelectronic circuit according to an embodiment of the present disclosure are illustrated. The first configuration of the sixth exemplary structure in FIG. 9A may be derived from the first configuration of the third exemplary structure illustrated in FIG. 6A by using a monitor circuit 500 having an M-fold redundancy instead of a twofold redundancy in the optoelectronic photodetector 550. A first subset of the optical component output channels 460 may be thru ports 46T, and a second subset of the optical component output channels 460 may be the drop ports 46D. The second configuration of the sixth exemplary structure in FIG. 9B may be derived from the first configuration of the sixth exemplary structure illustrated in FIG. 9A by using N optical components 450 to provide an N-fold redundancy instead of a twofold redundancy in the optical components 450.

Generally, integrating multiple redundant units in the optoelectronic device enhances system reliability and fault tolerance. The optical feedback function may detect the accuracy of components in real-time and may be manually adjusted to ensure component stability and reduce failure rates. The drop ports 46D provide confirmation of the stability and accuracy of the optical signal in real-time, promptly identifying and addressing any issues. Moreover, redundancy elements (such as the optical components 450) are added before the opto-electrical conversion by the optoelectronic photodetectors 550 to ensure stable and efficient conversion. Thus, embodiments of the present disclosure provide stable and efficient operation of the entire system, reduce failure rates, and improve system reliability. Additionally, the redundancy architecture of the present disclosure reduces the impact of single-component failures on the entire system. When one unit fails, other redundant units may take over its work and maintain system operation, thus increasing system availability.

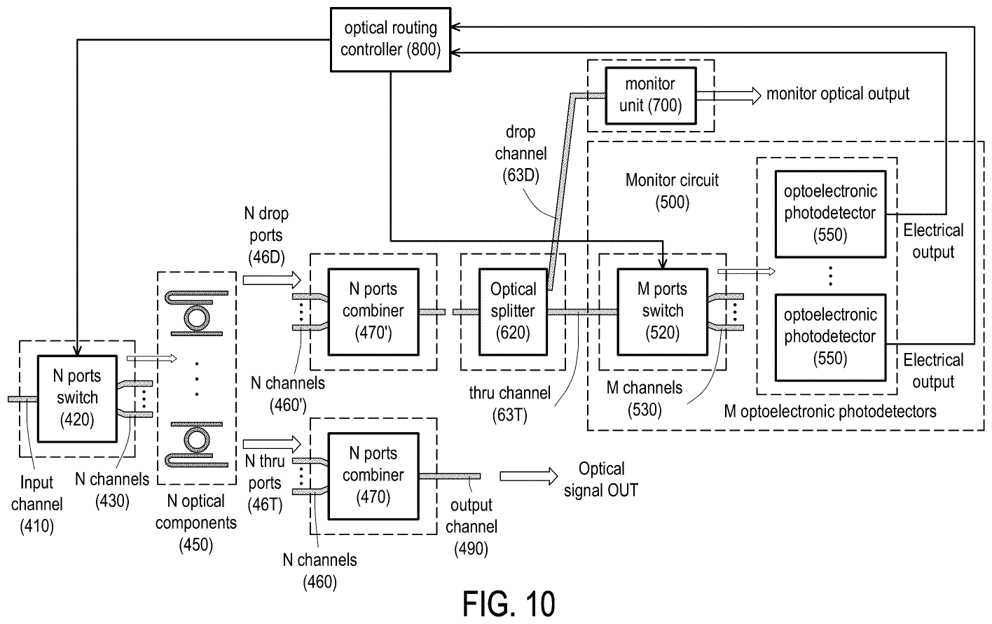

Referring to FIG. 10, a seventh exemplary optoelectronic circuit according to an embodiment of the present disclosure may be derived from the second embodiment of the sixth exemplary optoelectronic circuit illustrated in FIG. 9B by using an optical splitter 620 that splits an optical signal from the additional optical combiner 470′ into a first optical output that passes through a thru channel 63T and is subsequently transmitted to the second optical switch 520, and a second optical output that passes through a drop channel 63D and is directed to an optical monitor unit 700. The optical monitor unit 700 may function any of the functions described above. In other words, the input channel of the optical monitor unit 700 may be the drop channel 63D of the optical splitter 620 that is connected to an output port of the additional optical combiner 470′.

The various embodiments of the present disclosure provide a redundancy architecture which not only mitigates the risk of component failure but also enhances the overall system's fault tolerance, ensuring continuous operation even under component stress or failure. This approach reduces production downtime and system-level area wastage typically associated with the prior art, thereby enhancing the economic efficiency and environmental sustainability of the manufacturing process. Furthermore, the integration of system-level feedback mechanisms allows for ongoing adjustments and optimizations, which improve the accuracy and reliability of signal transmission within the system. Consequently, the disclosed embodiments offer a robust solution that increases both the yield and reliability of semiconductor devices, surpassing the limitations and challenges previously encountered in traditional manufacturing practices.

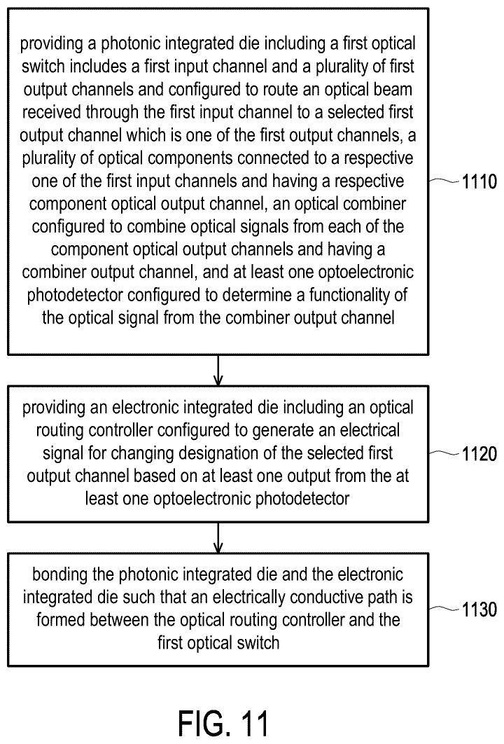

Referring to FIG. 11, a sequence of steps for manufacturing an optoelectronic device is illustrated in a flow chart.

Referring to step 1110 and FIGS. 2A-2C and 4-10, a photonic integrated die 100 is provided, which includes a first optical switch 420 comprising a first optical input channel 410 and a plurality of first optical output channels 430 and configured to route an optical signal received through the first optical input channel 410 to a selected first optical output channel 430 which is one of the first optical output channels 430. The photonic integrated die 100 further includes a plurality of optical components 450 connected to a respective one of the first optical output channels 430 and having a respective component optical output channel, and a first optical combiner 470 configured to combine optical signals from each of the component optical output channels and having a combiner optical output channel 490.

Referring to step 1120 and FIGS. 2D and 4-10, an electronic integrated die 200 is provided, which includes at least one optoelectronic photodetector 550 configured to determine a functionality of the optical signal from the combiner optical output channel 490, and an optical routing controller 800 configured to generate an electrical signal for changing designation of the selected first optical output channel 430 based on at least one output from the at least one optoelectronic photodetector 550.

Referring to step 1130 and FIGS. 1A, 2D, and 4-10, the photonic integrated die 100 and the electronic integrated die 200 may be bonded such that optical paths are formed between optical signals in the photonic integrated die 100 and the at least one optoelectronic photodetector 550.

In one embodiment, bonding the photonic integrated die 100 and the electronic integrated die 200 forms an electrically conductive path between the optical routing controller 800 and the first optical switch 420. In one embodiment, the first optical switch 420 comprises an electrically-tunable output selector that comprises a Mach-Zehnder interferometer including an electrically-tunable phase shifter; and the electrically conductive path between the optical routing controller 800 and the first optical switch 420 is configured to transmit an electrical control signal that is generated from the optical routing controller 800 to the electrically-tunable output selector.

In one embodiment, the at least one optoelectronic photodetector 550 comprises a plurality of optoelectronic photodetectors 550 located in the photonic integrated die 100; a bonded assembly of the photonic integrated die 100 and the electronic integrated die 200 comprises a monitor circuit 500 which comprises a plurality of series connections of a respective monitor-circuit optical channel 530 and a respective optoelectronic photodetector 550 among the plurality of optoelectronic photodetectors 550; and each of the monitor-circuit optical channels 530 extend through a portion of the photonic integrated die 100 and through a portion of the electronic integrated die 200.

In one embodiment, the monitor circuit 500 comprises a second optical switch 520 located in the photonic integrated die 100; the second optical switch 520 is configured to route an optical signal from the combiner optical output channel 490 to a selected second optical output channel which is one of the monitor-circuit optical channels 530; and the optical routing controller 800 is configured to change designation of the selected second optical output channel among the monitor-circuit optical channels 530 based on electrical output signals from the plurality of optoelectronic photodetectors 550.

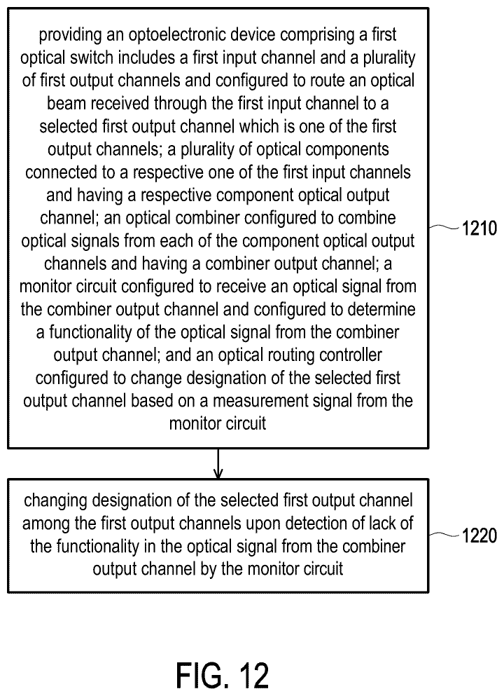

Referring to FIG. 12, a sequence of steps for operating a device of the present disclosure is illustrated in a flow chart.

Referring to step 1210 and FIGS. 1A-10, an optoelectronic device is provided, which comprises a first optical switch 420 comprising a first optical input channel 410 and a plurality of first optical output channels 430 and configured to route an optical signal received through the first optical input channel 410 to a selected first optical output channel 430 which is one of the first optical output channels 430; a plurality of optical components 450 connected to a respective one of the first optical output channels 430 and having a respective component optical output channel; a first optical combiner 470 configured to combine optical signals from each of the component optical output channels and having a combiner optical output channel 490; a monitor circuit 500 configured to receive an optical signal from the combiner optical output channel 490 and configured to determine a functionality of the optical signal from the combiner optical output channel 490; and an optical routing controller 800 configured to change designation of the selected first optical output channel 430 based on a measurement signal from the monitor circuit 500.

Referring to step 1220 and FIGS. 4-10, designation of the selected first optical output channel 430 may be changed among the first optical output channels 430 upon detection of lack of the functionality in the optical signal from the combiner optical output channel 490 by the monitor circuit 500.

In one embodiment, the designation of the selected first optical output channel 430 is changed by transmitting an electrical control signal from the optical routing controller 800 to the first optical switch 420 through an electrically conductive path that includes a photonic-die bonding pad 198 of the photonic integrated die 100 and through an electronic-die bonding pad 298 of the electronic integrated die 200. In one embodiment, the first optical switch 420 comprises an electrically-tunable output selector that comprises a Mach-Zehnder interferometer including an electrically-tunable phase shifter; and the electrically conductive signal is generated by the optical routing controller 800 and is received by the electrically-tunable output selector.

In one embodiment, the monitor circuit 500 comprises a second optical switch 520 and a plurality of series connections of a respective monitor-circuit optical channel 530 and a respective optoelectronic photodetector 550; the second optical switch 520 is configured to route an optical signal from the combiner optical output channel 490 to a selected second optical output channel which is one of the monitor-circuit optical channels 530; and the monitor circuit 500 is configured to monitor electrical output signals from the optoelectronic photodetectors 550. In one embodiment, the method further comprises changing designation of the selected second optical output channel among the monitor-circuit optical channels 530 based on the electrical output signals from the optoelectronic photodetectors 550 during testing of the optoelectronic device or during real-time operation of the optoelectronic device.

Referring collectively to FIGS. 1A-10 and according to various embodiments of the present disclosure, an optoelectronic device is provided, which comprises: a first optical switch 420 comprising a first optical input channel 410 and a plurality of first optical output channels 430 and configured to route an optical signal received through the first optical input channel 410 to a selected first optical output channel 430 which is one of the first optical output channels 430; a plurality of optical components 450 having a respective optical input channel connected to a respective one of the plurality of first optical output channels 430 and having a respective optical component output channel 460; a first optical combiner 470 configured to combine optical signals from each of the optical component output channels 460 and having a combiner optical output channel 490; a monitor circuit 500 configured to receive an optical signal from the combiner optical output channel 490 and configured to determine a functionality of the optical signal from the combiner optical output channel 490; and an optical routing controller 800 configured to change designation of the selected first optical output channel 430 among the plurality of first optical output channels 430 based on a measurement signal from the monitor circuit 500.

In one embodiment, the monitor circuit 500 comprises at least one optoelectronic photodetector 550 configured to generate an electrical signal from the optical signal from the combiner optical output channel 490 as the measurement signal. In one embodiment, the optical routing controller 800 is configured to change the designation of the selected first optical output channel 430 based on a magnitude of the electrical signal that is generated by the monitor circuit 500.

In one embodiment, the first optical switch 420, the plurality of optical components 450, and the first optical combiner 470 are located in a photonic integrated die 100; and the at least one optoelectronic photodetector 550 and the optical routing controller 800 are located in an electronic integrated die 200. In one embodiment, the photonic integrated die 100 and the electronic integrated die 200 are bonded to each other directly or through at least one intermediate die such that at least one optical path is provided between the first optical combiner 470 and the at least one photonic integrated die 100. In one embodiment, at least one electrically conductive path extends from an output node of the optical routing controller 800 to a control node of the first optical switch 420; and each of the at least one electrically conductive path comprises a respective photonic-die bonding pad 198 and a respective electronic-die bonding pad 298.

In one embodiment, the monitor circuit 500 comprises a plurality of series connections of a respective monitor-circuit optical channel 530 and a respective optoelectronic photodetector 550 configured to generate a respective electrical signal upon detection of an optical signal thereupon. In one embodiment, the monitor circuit 500 comprises a second optical switch 520; and the second optical switch 520 is configured to route the optical signal from the combiner optical output channel 490 to a selected second optical output channel which is one of the monitor-circuit optical channels 530. In one embodiment, the optical routing controller 800 is configured to change designation of the selected second optical output channel among the monitor-circuit optical channels 530 based on the measurement signal from the monitor circuit 500.

In one embodiment, the first optical switch 420 comprises an electrically-tunable output selector that comprises a Mach-Zehnder interferometer including an electrically-tunable phase shifter; and the optical routing controller 800 is configured to generate an electrical control signal that is applied to the electrically-tunable output selector.

The foregoing outlines features of several embodiments so that those skilled in the art may better understand the aspects of the present disclosure. Each embodiment described using the term “comprises” also inherently discloses additional embodiments in which the term “comprises” is replaced with “consists essentially of” or with the term “consists of,” unless expressly disclosed otherwise herein. Whenever two or more elements are listed as alternatives in a same paragraph of in different paragraphs, a Markush group including a listing of the two or more elements is also impliedly disclosed. Whenever the auxiliary verb “can” is used in this disclosure to describe formation of an element or performance of a processing step, an embodiment in which such an element or such a processing step is not performed is also expressly contemplated, provided that the resulting apparatus or device may provide an equivalent result. As such, the auxiliary verb “can” as applied to formation of an element or performance of a processing step should also be interpreted as “may” or as “may, or may not” whenever omission of formation of such an element or such a processing step is capable of providing the same result or equivalent results, the equivalent results including somewhat superior results and somewhat inferior results. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An optoelectronic device comprising:
a first optical switch comprising a first optical input channel and a plurality of first optical output channels and configured to route an optical signal received through the first optical input channel to a selected first optical output channel which is one of the plurality of first optical output channels;
a plurality of optical components having a respective optical input channel connected to a respective one of the plurality of first optical output channels and having a respective optical component output channel;
a first optical combiner configured to combine optical signals from each of the plurality of optical component output channels and having a combiner optical output channel;
a monitor circuit configured to receive an optical signal from the combiner optical output channel and configured to determine a functionality of the optical signal from the combiner optical output channel; and
an optical routing controller configured to change designation of the selected first optical output channel among the plurality of first optical output channels based on a measurement signal from the monitor circuit.

2. The optoelectronic device of claim 1, wherein the monitor circuit comprises at least one optoelectronic photodetector configured to generate an electrical signal from the optical signal from the combiner optical output channel as the measurement signal.

3. The optoelectronic device of claim 2, wherein the optical routing controller is configured to change the designation of the selected first optical output channel based on a magnitude of the electrical signal that is generated by the monitor circuit.

4. The optoelectronic device of claim 2, wherein:
the first optical switch, the plurality of optical components, the first optical combiner, and the at least one optoelectronic photodetector are located in a photonic integrated die; and
the optical routing controller are located in an electronic integrated die.

5. The optoelectronic device of claim 4, wherein the photonic integrated die and the electronic integrated die are bonded to each other directly or through at least one intermediate die.

6. The optoelectronic device of claim 5, wherein:
at least one electrically conductive path extends from an output node of the optical routing controller to a control node of the first optical switch; and
each of the at least one electrically conductive path comprises a respective photonic-die bonding pad and a respective electronic-die bonding pad.

7. The optoelectronic device of claim 1, wherein the monitor circuit comprises a plurality of series connections of a respective monitor-circuit optical channel and a respective optoelectronic photodetector configured to generate a respective electrical signal upon detection of an optical signal thereupon.

8. The optoelectronic device of claim 7, wherein:
the monitor circuit comprises a second optical switch; and
the second optical switch is configured to route the optical signal from the combiner optical output channel to a selected second optical output channel which is one of the monitor-circuit optical channels.

9. The optoelectronic device of claim 8, wherein the optical routing controller is configured to change designation of the selected second optical output channel among the monitor-circuit optical channels based on the measurement signal from the monitor circuit.

10. The optoelectronic device of claim 1, wherein:
the first optical switch comprises an electrically-tunable output selector that comprises a Mach-Zehnder interferometer including an electrically-tunable phase shifter; and
the optical routing controller is configured to generate an electrical control signal that is applied to the electrically-tunable output selector.

11. A method of manufacturing an optoelectronic device, comprising:
providing a photonic integrated die including a first optical switch comprising a first optical input channel and a plurality of first optical output channels and configured to route an optical signal received through the first optical input channel to a selected first optical output channel which is one of the plurality of first optical output channels, a plurality of optical components connected to a respective one of the first optical output channels and having a respective component optical output channel, a first optical combiner configured to combine optical signals from each of the component optical output channels and having a combiner optical output channel, and at least one optoelectronic photodetector configured to determine a functionality of the optical signal from the combiner optical output channel;
providing an electronic integrated die including an optical routing controller configured to generate an electrical signal for changing designation of the selected first optical output channel based on at least one output from the at least one optoelectronic photodetector; and
bonding the photonic integrated die and the electronic integrated die such that an electrically conductive path is formed between the optical routing controller and the first optical switch.

12. The method of claim 11, wherein the first optical switch comprises an electrically-tunable output selector that comprises a Mach-Zehnder interferometer including an electrically-tunable phase shifter.

13. The method of claim 12, wherein the electrically conductive path between the optical routing controller and the first optical switch is configured to transmit an electrical control signal that is generated from the optical routing controller to the electrically-tunable output selector.

14. The method of claim 11, wherein:
the at least one optoelectronic photodetector comprises a plurality of optoelectronic photodetectors located in the photonic integrated die;
a bonded assembly of the photonic integrated die and the electronic integrated die comprises a monitor circuit which comprises a plurality of series connections of a respective monitor-circuit optical channel and a respective optoelectronic photodetector among the plurality of optoelectronic photodetectors; and
each of the monitor-circuit optical channels extend through a portion of the photonic integrated die and through a portion of the electronic integrated die.

15. The method of claim 14, wherein:
the monitor circuit comprises a second optical switch located in the photonic integrated die;
the second optical switch is configured to route an optical signal from the combiner optical output channel to a selected second optical output channel which is one of the monitor-circuit optical channels; and
the optical routing controller is configured to change designation of the selected second optical output channel among the monitor-circuit optical channels based on electrical output signals from the plurality of optoelectronic photodetectors.

16. A method of operating a device, comprising:
providing an optoelectronic device comprising a first optical switch comprising:
a first optical input channel and a plurality of first optical output channels and configured to route an optical signal received through the first optical input channel to a selected first optical output channel which is one of the plurality of first optical output channels;
a plurality of optical components connected to a respective one of the first optical output channels and having a respective component optical output channel;
a first optical combiner configured to combine optical signals from each of the component optical output channels and having a combiner optical output channel;
a monitor circuit configured to receive an optical signal from the combiner optical output channel and configured to determine a functionality of the optical signal from the combiner optical output channel; and
an optical routing controller configured to change designation of the selected first optical output channel based on a measurement signal from the monitor circuit; and
changing designation of the selected first optical output channel among the first optical output channels upon detection of lack of the functionality in the optical signal from the combiner optical output channel by the monitor circuit.

17. The method of claim 16, wherein the designation of the selected first optical output channel is changed by transmitting an electrical control signal from the optical routing controller to the first optical switch through an electrically conductive path that includes a photonic-die bonding pad of a photonic integrated die and through an electronic-die bonding pad of an electronic integrated die.

18. The method of claim 17, wherein:
the first optical switch comprises an electrically-tunable output selector that comprises a Mach-Zehnder interferometer including an electrically-tunable phase shifter; and
an electrically conductive signal is generated by the optical routing controller and is received by the electrically-tunable output selector.

19. The method of claim 16, wherein:
the monitor circuit comprises a second optical switch and a plurality of series connections of a respective monitor-circuit optical channel and a respective optoelectronic photodetector;
the second optical switch is configured to route an optical signal from the combiner optical output channel to a selected second optical output channel which is one of the monitor-circuit optical channels; and
the monitor circuit is configured to monitor electrical output signals from optoelectronic photodetectors.

20. The method of claim 19, further comprising changing designation of the selected second optical output channel among the monitor-circuit optical channels based on the electrical output signals from the optoelectronic photodetectors during testing of the optoelectronic device or during real-time operation of the optoelectronic device.
